(19) United States
(12) Patent Application Publication
(10) Pub. No.: US 2019/0385171 A1
(43) Pub. Date: Dec. 19, 2019

(54) PROXY CARD FOR MOBILE PAYMENT

(71) Applicant: BEAUTIFUL CARD CORPORATION, TAOYUAN CITY (TW)

(72) Inventor: MENG-JEN CHENG, TAOYUAN CITY (TW)

(21) Appl. No.: 16/010,811

(22) Filed: Jun. 18, 2018

(51) Int. Cl. G06Q 20/40; G06Q 20/34; G06Q 20/32

(52) U.S. Cl. CPC G06Q 20/40145; G06Q 20/3278; G06Q 20/34

(57) ABSTRACT

A proxy card for mobile payment has a card body; a processor disposed at the card body to store a user's fingerprint data, personal data, mobile payment information and transaction data; a power unit disposed at the card body and electrically-connected to the processor to supply power; a fingerprint receiving unit disposed at the card body and electrically-connected to the processor to receive the fingerprint data for recognition by the processor; a display unit disposed at the card body and electrically-connected to the processor to display a first prompt while fingerprint recognition is occurring, a second prompt while mobile payment information storage is occurring, and a third prompt while mobile payment is occurring; and a wireless communication unit disposed at the card body and electrically-connected to the processor to connect to a mobile communication apparatus to store the mobile payment information in the processor.

### FIELD OF THE INVENTION

The present disclosure relates to proxy cards for mobile payment and, more particularly, to a proxy card for use in mobile payment transactions.

### BACKGROUND OF THE INVENTION

Owing to advancement of information technology and communication technology, smartphones are so popular with people that mobile payment is on the rise globally.

With every smartphone being equipped with an NFC communication interface, mobile payment is completed by putting the smartphone in front of a sensing module, without being authorized. Payers either debit payments against their prepaid accounts or bank accounts, or have the payments included in their phone bills. These render mobile payment convenient and popular.

However, the prior art has two drawbacks. First, mobile payment can fail because of a low power level of the smartphone or weak signal reception. Second, mobile payment requires payees to put the payers' smartphones in front of the payees' sensing modules, and the payees' transient custody of the payers' smartphones poses a threat to transaction safety and payer privacy.

Therefore, it is imperative to provide a proxy card for mobile payment. The proxy card stores mobile payment information from a mobile communication apparatus and serves as a transaction tool. Hence, the proxy card not only precludes the chance that mobile payment will fail because of a low power level of the mobile communication apparatus or weak signal reception but also dispenses with the need for a payer to hand over the mobile communication apparatus and the proxy card. Therefore, the proxy card enhances transaction safety, protects payer privacy, and augments mobile payment convenience.

### SUMMARY OF THE INVENTION

In view of the aforesaid drawbacks of the prior art, it is an objective of the present disclosure to provide a proxy card for mobile payment. The proxy card stores mobile payment information from a mobile communication apparatus and serves as a transaction tool. Hence, the proxy card not only precludes the chance that mobile payment will fail because of a low power level of the mobile communication apparatus or weak signal reception but also dispenses with the need for the card holder to hand over the mobile communication apparatus and the proxy card. Therefore, the proxy card enhances transaction safety, protects payer privacy, and augments mobile payment convenience.

In order to achieve the above and other objectives, the present disclosure provides a proxy card for mobile payment. The proxy card for mobile payment comprises: a card body, a processor disposed at the card body, a power unit disposed at the card body and electrically connected to the processor, a fingerprint receiving unit disposed at the card body and electrically connected to the processor, a display unit disposed at the card body and electrically connected to the processor, and a wireless communication unit disposed at the card body and electrically connected to the processor. The processor stores a user's fingerprint data, personal data, mobile payment information and transaction data. The power unit supplies power. The fingerprint receiving unit receives the user's fingerprint data for recognition by the processor. The display unit is adapted to display a first prompt while fingerprint recognition is taking place, display a second prompt while mobile payment information storage is taking place, and display a third prompt while mobile payment is taking place. The wireless communication unit connects to a mobile communication apparatus to store the mobile payment information in the processor.

Regarding the proxy card for mobile payment, the processor comprises a safety module, a verification unit and a storage unit.

Regarding the proxy card for mobile payment, the power unit is a secondary battery or a primary battery.

Regarding the proxy card for mobile payment, the fingerprint receiving unit is a hard fingerprint receiving unit or a flexible fingerprint receiving unit.

Regarding the proxy card for mobile payment, the display unit has a flexible monitor, at least one luminous element or a combination thereof.

Regarding the proxy card for mobile payment, the wireless communication unit has a first communication interface and a second communication interface.

Regarding the proxy card for mobile payment, the first communication interface is a Bluetooth communication protocol.

Regarding the proxy card for mobile payment, the second communication interface is an NFC communication protocol.

Regarding the proxy card for mobile payment, further comprises a rectify-stabilizing unit disposed at the card body and electrically connected among the processor, the power unit and the wireless communication unit.

Regarding the proxy card for mobile payment, further comprises an input unit disposed at the card body, electrically connected to the processor, and implemented by a leaf spring switch, a resistance touch switch, a capacitance touch switch or a fingerprint switch.

Therefore, the present disclosure provides a proxy card for mobile payment. The proxy card stores mobile payment information from a mobile communication apparatus and serves as a transaction tool. Hence, the proxy card not only precludes the chance that mobile payment will fail because of a low power level of the mobile communication apparatus or weak signal reception but also dispenses with the need for the card holder to hand over the mobile communication apparatus and the proxy card. Therefore, the proxy card enhances transaction safety, protects payer privacy, and augments mobile payment convenience.

### BRIEF DESCRIPTION OF THE DRAWINGS

FIG. 1 is a perspective view of a proxy card for mobile payment according to a preferred embodiment of the present disclosure;

FIG. 2 is a block diagram of the proxy card for mobile payment according to a preferred embodiment of the present disclosure;

FIG. 3 is a schematic view of a storage state of the proxy card for mobile payment according to a preferred embodiment of the present disclosure; and

FIG. 4 is a schematic view of a transaction state of the proxy card for mobile payment according to a preferred embodiment of the present disclosure.

### DETAILED DESCRIPTION OF THE PREFERRED EMBODIMENTS

Objectives, features, and advantages of the present disclosure are hereunder illustrated with specific embodiments in conjunction with the accompanying drawings, in which:

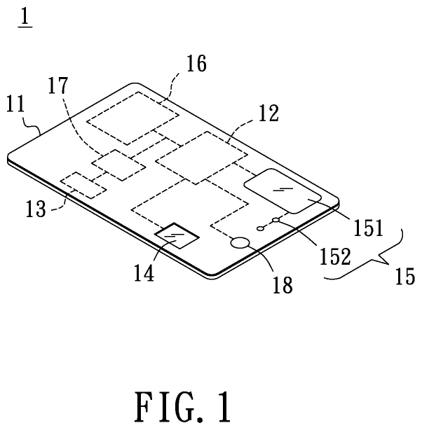

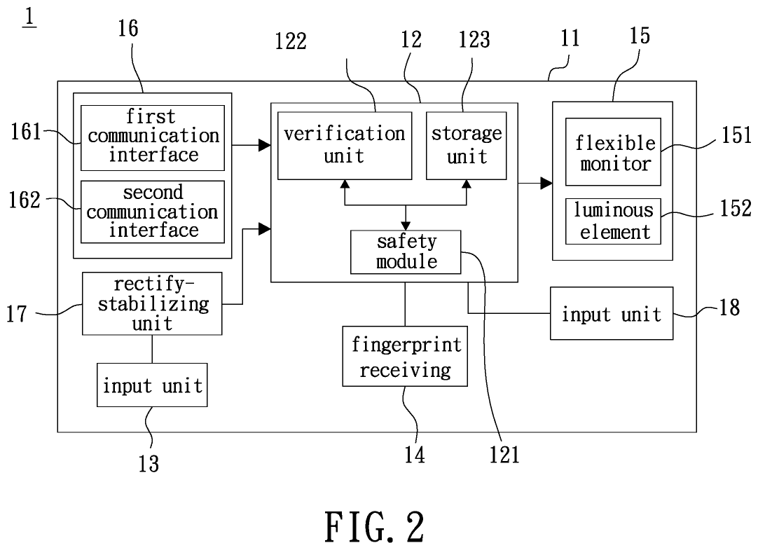

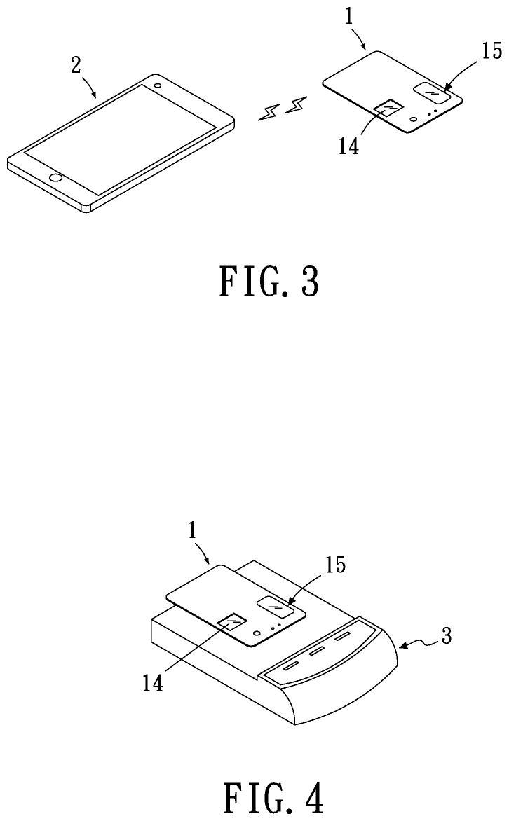

Referring to FIG. 1 through FIG. 4, the present disclosure provides a proxy card 1 for mobile payment. The proxy card 1 comprises a card body 11, a processor 12, a power unit 13, a fingerprint receiving unit 14, a display unit 15 and a wireless communication unit 16.

The card body 11 carries the processor 12, the power unit 13, the fingerprint receiving unit 14, the display unit 15 and the wireless communication unit 16.

The processor 12 is disposed at the card body 11. The processor 12 stores a user's fingerprint data, personal data, mobile payment information and transaction data and performs computation required for fingerprint recognition, mobile payment information storage and mobile payment

The power unit 13 is disposed at the card body 11 and electrically connected to the processor 12. The power unit 13 is a secondary battery or a primary battery. The power unit 13 supplies power required for operation of the processor 12, the fingerprint receiving unit 14, the display unit 15 and the wireless communication unit 16.

The fingerprint receiving unit 14 is disposed at the card body 11 and electrically connected to the processor 12. The fingerprint receiving unit 14 receives the user's fingerprint data for recognition by the processor 12.

The display unit 15 is disposed at the card body 11 and electrically connected to the processor 12. The display unit 15 displays a first prompt while fingerprint recognition is taking place, displays a second prompt while mobile payment information storage is taking place, and displays a third prompt while mobile payment is taking place.

The wireless communication unit 16 is disposed at the card body and electrically connected to the processor. The wireless communication unit 16 connects to a mobile communication apparatus 2 to store the mobile payment information in the processor 12.

A process of storing in the processor 12 the mobile payment information from the mobile communication apparatus 2 requires a card holder to touch the fingerprint receiving unit 14 of the proxy card 1 with a finger configured for fingerprint recognition, so as for the fingerprint receiving unit 14 to receive the finger's fingerprint. Then, the processor 12 performs recognition and verification on the finger's fingerprint. Upon confirmation that the fingerprint belongs to the card holder, the display unit 15 outputs a confirmation message, such as a visual signal or a text message. Afterward, the processor 22 starts the wireless communication unit 16 such that the wireless communication unit 16 connects to the mobile communication apparatus 2, allowing the proxy card 1 to perform handshake with the mobile communication apparatus 2. As a result, the mobile payment information from the mobile communication apparatus 2 is stored in the processor 12. Furthermore, the display unit 15 outputs a storage-related message, such as a visual signal or a text message, to inform the card holder that the mobile payment information is being stored or has been stored. Hence, the mobile payment information from the mobile communication apparatus 2 can be stored in the processor 12 of the proxy card 1.

To conduct a transaction with the proxy card 1, using the mobile payment information, the card holder puts the proxy card 1 in front of a sensing apparatus 3 in a payee's possession and touches the fingerprint receiving unit 14 of the proxy card 1 with a finger configured for fingerprint recognition, so as for the fingerprint receiving unit 14 to receive the finger's fingerprint. Then, the processor 12 performs recognition and verification on the finger's fingerprint. Upon confirmation that the fingerprint belongs to the card holder, the display unit 15 outputs a confirmation message, such as a visual signal or a text message. Afterward, the processor 12 starts the wireless communication unit 16 such that the wireless communication unit 16 connects to the sensing apparatus 3, allowing the proxy card 1 to perform handshake with the sensing apparatus 3. As a result, payment is made by the processor 12 in accordance with the mobile payment information, and the display unit 15 outputs a transaction-related message, such as a visual signal or a text message, to inform the card holder that the transaction is concluded in accordance with the card holder's mobile payment information. Therefore, the transaction is completed by mobile payment, using the proxy card 1, to not only preclude the chance that mobile payment will fail because of a low power level of the mobile communication apparatus 2 or weak signal reception but also dispenses with the need for the card holder to hand over the mobile communication apparatus 2 and the proxy card 1. Therefore, the proxy card enhances transaction safety, protects payer privacy, and augments mobile payment convenience.

During the aforesaid process of storing the mobile payment information and the aforesaid process of conducting a transaction in accordance with the mobile payment information, if the fingerprint receiving unit 14 confirms that the fingerprint does not belong to the card holder, the processor 12 will send an error message, whereas the display unit 15 automatically outputs an error message, such as a visual signal or a text message. Afterward, the processor 12 either takes no action or shuts down, so as to enhance transaction safety.

In an embodiment of the present disclosure, the processor 12 comprises a safety module 121, a verification unit 122 and a storage unit 123. The safety module 121 performs computation required for fingerprint recognition, mobile payment information storage, and mobile payment. The verification unit 122 operates in conjunction with the safety module 121 to receive the fingerprint data from the fingerprint receiving unit 14 and verify it. The storage unit 123 stores the user's fingerprint data, personal data, mobile payment information and transaction data. Therefore, the proxy card for mobile payment enhances the safety during mobile payment information storage and mobile payment.

In an embodiment of the present disclosure, the fingerprint receiving unit 14 is a hard fingerprint receiving unit or a flexible fingerprint receiving unit, which operates in conjunction with the card body 11 or operates as needed, so as for the present disclosure to meet practical needs better.

In an embodiment of the present disclosure, the display unit 15 has a flexible monitor 151, at least one luminous element 152 or a combination thereof. The present disclosure is exemplified by an embodiment which requires both the flexible monitor 151 and at least one luminous element 152. The storage unit 123 of the processor 12 is preconfigured with a display mode of the flexible monitor 151 to enable the flexible monitor 151 to output a related text message. The luminous element 152 is an LED. During a manufacturing process of the proxy card for mobile payment, the storage unit 123 of the processor 12 is preconfigured with a display mode of the luminous element 152. Examples of the display mode include continuous lighting, flashing, recurring lighting, or changing color. Hence, the luminous element 152 outputs a related message, so as to meet various needs for a display status.

In an embodiment of the present disclosure, the wireless communication unit 16 has a first communication interface 161 and a second communication interface 162. The first communication interface 161 is a Bluetooth communication protocol, and the second communication interface 162 is an NFC communication protocol. Therefore, the first communication interface 161 connects to the mobile communication apparatus 2 so as to effect storage of the mobile payment information, whereas the second communication interface 162 connects to the sensing apparatus 3 so as to effect mobile payment, thereby meeting the need for variable connections.

In an embodiment of the present disclosure, the proxy card for mobile payment further comprises a rectify-stabilizing unit 17. The rectify-stabilizing unit 17 is disposed at the card body 11 and electrically connected among the processor 11, the power unit 13, and the wireless communication unit 16. The rectify-stabilizing unit 17 stabilizes the operating voltage of the power unit 13 and precludes any unstable voltage which might otherwise damage the processor 12.

In an embodiment of the present disclosure, the proxy card for mobile payment further comprises an input unit 18. The input unit 18 is disposed at the card body 11 and electrically connected to the processor 12. The input unit 18 is implemented by a leaf spring switch, a resistance touch switch, a capacitance touch switch or a fingerprint switch. The input unit 18 not only gains access to electric power and then starts the processor 12 and the fingerprint receiving unit 14 to therefore exercise control over fingerprint recognition, but is also conducive to user-related configuration of the processor 12, so as to meet various needs for use status and manufacturing.

The present disclosure is disclosed above by preferred embodiments. However, persons skilled in the art should understand that the preferred embodiments are illustrative of the present disclosure only, but shall not be interpreted as restrictive of the scope of the present disclosure. Hence, all equivalent modifications and replacements made to the aforesaid embodiments shall fall within the scope of the present disclosure. Accordingly, the legal protection for the present disclosure shall be defined by the appended claims.

What is claimed is:

1. A proxy card for mobile payment, the proxy card comprising:
a card body;
a processor disposed at the card body to store a user's fingerprint data, personal data, mobile payment information and transaction data;
a power unit disposed at the card body and electrically connected to the processor to supply power;
a fingerprint receiving unit disposed at the card body and electrically connected to the processor to receive the fingerprint data for recognition by the processor;
a display unit disposed at the card body and electrically connected to the processor to display a first prompt while fingerprint recognition is taking place, display a second prompt while mobile payment information storage is taking place, and display a third prompt while mobile payment is taking place; and
a wireless communication unit disposed at the card body and electrically connected to the processor, wherein the wireless communication unit connects to a mobile communication apparatus to store the mobile payment information in the processor.

2. The proxy card for mobile payment of claim 1, wherein the processor comprises a safety module, a verification unit and a storage unit.

3. The proxy card for mobile payment of claim 1, wherein the power unit is a secondary battery or a primary battery.

4. The proxy card for mobile payment of claim 1, wherein the fingerprint receiving unit is a hard fingerprint receiving unit or a flexible fingerprint receiving unit.

5. The proxy card for mobile payment of claim 1, wherein the display unit has a flexible monitor, at least one luminous element or a combination thereof.

6. The proxy card for mobile payment of claim 1, wherein the wireless communication unit has a first communication interface and a second communication interface.

7. The proxy card for mobile payment of claim 6, wherein the first communication interface is a Bluetooth communication protocol.

8. The proxy card for mobile payment of claim 6, wherein the second communication interface is an NFC communication protocol.

9. The proxy card for mobile payment of claim 1, further comprising a rectify-stabilizing unit disposed at the card body and electrically connected among the processor, the power unit and the wireless communication unit.

10. The proxy card for mobile payment of claim 1, further comprising an input unit disposed at the card body, electrically connected to the processor, and implemented by a leaf spring switch, a resistance touch switch, a capacitance touch switch or a fingerprint switch.
